(19) United States
(12) Patent Application Publication
(10) Pub. No.: US 2007/0200546 A1
(43) Pub. Date: Aug. 30, 2007

(54) Reference voltage generating circuit for generating low reference voltages

(75) Inventors: Andrea Logiudice, Padova (IT); Bernhard Wotruba, Padova (IT)

Correspondence Address: Maginot, Moore & Beck;Chase Tower, Suite 3250, 111 Monument Circle, Indianapolis, IN, 46204, US

(73) Assignee: Infineon Technologies AG, Munich (DE)

(21) Appl. No.: 11/488,451

(22) Filed: Jul. 18, 2006

(30) Foreign Application Priority Data
Jul. 18, 2005 (DE) 102005033434.2-32

(51) Int. Cl. G05F 3/20

(52) U.S. Cl. 323/316

(57) ABSTRACT

The invention relates to a reference voltage generating circuit comprising:
a voltage source circuit (10) which is constructed for providing at an output (15) a first reference voltage (Vbe/a) which is proportional to the voltage (Vbe) across a pn junction, polarized in the forward direction, of a bipolar component (11) and which is lower than this voltage,
an amplifier arrangement (2) having a first and second input (25, 26), an output (27) at which an output voltage (Vout) is available, a differential amplifier stage (20) which has at least two semiconductor components (21, 22; 121, 122), and an output stage (30), the first reference voltage (Vbe/a) being supplied to the first input (25), the output (27) being fed back to the second input (26) and the amplifier arrangement having an offset which is proportional to the thermal voltage of a semiconductor material of the at least two semiconductor components (21, 22; 121, 122) of the differential amplifier stage (20) and wherein a second reference voltage (Vout) is available at the output (OUT).

The invention relates to a reference voltage generating circuit, particularly a reference voltage generating circuit for generating a reference voltage which is lower than a bandgap voltage.

To generate temperature-resistant reference voltages, it is known to use so-called bandgap references which deliver a bandgap voltage as reference voltage. Such bandgap references are described, for example, in Tietze, Schenk: “Halbleiter-Schaltungstechnik” [Semiconductor circuit technology], 11th edition, Springer-Verlag, Berlin, ISBN 3-540-64192-0, pages 975, 976.

A bandgap voltage is composed of the voltage across a pn junction, polarized in the forward direction, of a bipolar component, for example the pn junction between base and emitter of a bipolar transistor, and the difference of the voltages across pn junctions, polarized in a forward direction, of two bipolar components. The following thus applies:
Vbg=Vbe+K·ΔVbe=Vbe+A·U_{T} (1),

where Vbg is the bandgap voltage, Vbe is the voltage across the pn junction and ΔVbe is the difference between two such voltages present across pn junctions. This principle makes use of the fact that the voltage Vbe across the pn junction polarized in the forward direction and the voltage difference ΔVbe have temperature coefficients with opposite signs so that an approximately temperature-independent voltage Vbg is obtained with a suitable choice of the weighting factor K. The temperature coefficient of the base-emitter voltage of a silicon bipolar transistor is (27° C.=300 K) at a set operating point of 0.6 V −2 mV/K at room temperature. The difference ΔVbe is proportional to the thermal voltage U_{T}, which has a positive temperature coefficient and for which the following applies:
U_{T}=k·T/q (2),

where k is the Boltzmann constant, T is the absolute temperature and q is the elementary charge. At T=300 K, U_{T}˜26 mV for this voltage in silicon. The bandgap voltage is about 1.26 V for silicon and is obtained when the proportionality factor A is set in such a way that the temperature coefficient of the second voltage component (A·U_{T}) is about +2 mV/K so that an overall temperature coefficient of zero is obtained for the voltage Vbg.

As the pattern widths of integrated circuits become smaller, it becomes possible to construct circuits which need a lower supply voltage. There is thus a demand for reference voltage generating circuits which are capable of generating temperature-resistant reference voltages which are lower than the bandgap voltage of silicon or of another semiconductor material used, respectively.

Referring to FIG. 1, such a voltage could be generated in a simple manner by applying the bandgap voltage Vbg generated by a conventional bandgap reference 200 to a voltage divider 213, 214 which delivers a subdivided voltage as reference voltage Vsb. To reduce the output impedance, this circuit requires an operational amplifier 300 connected as buffer, which amplifies the subdivided voltage Vsb by a gain factor of one and delivers the reference voltage at its output. The disadvantageous factor is here that the operational amplifier 300 requires additional circuit area and that the operational amplifier can also have offset which corrupts the reference voltage.

It is the aim of the invention to provide a reference voltage generating circuit which is capable of providing a lower reference voltage than a bandgap voltage, and providing a method for generating such a reference voltage.

This aim is achieved by a reference voltage generating circuit as claimed in claim 1 and by a method as claimed in claim 13. Advantageous embodiments of the invention are the subject matter of the subclaims.

The reference voltage generating circuit according to the invention has a voltage source circuit which is constructed for providing at an output a first reference voltage which is proportional to the voltage across a pn junction, polarized in the forward direction, of a bipolar component and which is lower than this voltage. The reference voltage generating circuit also has an amplifier arrangement having a first and second input, an output, a differential amplifier stage which has at least two semiconductor components, and an output stage. The first reference voltage generated by the voltage source circuit is supplied to the first input of the amplifier arrangement, the output of the amplifier arrangement is fed back to the second input and the amplifier arrangement has an offset which is proportional to the thermal voltage of a semiconductor material of the at least two semiconductor components of the differential amplifier stage. At the output of the amplifier arrangement, a second reference voltage is available which is at least approximately temperature-independent.

When silicon is used as semiconductor material, the first reference voltage has a negative temperature coefficient. In the circuit arrangement according to the invention, any resultant temperature drift is compensated for by the offset of the amplifier arrangement which is proportional to the thermal voltage which has a positive temperature coefficient. The proportionality factor between the offset and the thermal voltage and the proportionality factor between the voltage at the pn junction match one another in such a manner that the temperature coefficient of a voltage present at the output of the amplifier arrangement is at least approximately zero.

In the circuit arrangement according to the invention, the amplifier arrangement fulfils two functions: firstly, it adds an offset to the first reference voltage delivered by the voltage source circuit, the temperature coefficient of which offset has an opposite sign to the temperature coefficient of the first reference voltage. Secondly, it provides a sufficiently low output impedance of the reference voltage generating circuit so that no further buffer is required.

The offset of the amplifier arrangement is dependent on the dimensioning of the two semiconductor components used as input components in the differential amplifier stage. The semiconductor components can be bipolar components, especially bipolar transistors. However, these input components can also be MOS transistors which are operated in the so-called sub-threshold range.

The method according to the invention for providing a temperature-independent reference voltage comprises the provision of a first voltage which is proportional to the voltage across a pn junction polarized in the forward direction, and which is lower than this voltage, and the adding of a second voltage to the first reference voltage, which is proportional to the thermal voltage of the semiconductor material of the pn junction, wherein the proportionality factors between the first voltage and the voltage at the pn junction and between the second voltage and the thermal voltage are matched to one another in such a manner that the sum of the temperature coefficients of the first and second voltage is zero.

In the text which follows, the present invention will be explained in greater detail with reference to exemplary embodiments.

FIG. 1 shows a circuit arrangement according to the prior art for generating a reference voltage which is lower than a bandgap voltage.

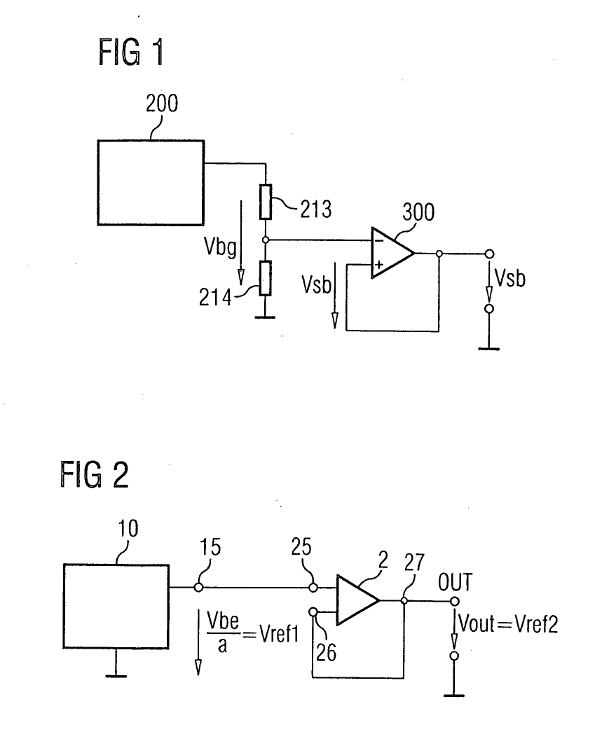

FIG. 2 shows the basic principle of the reference voltage generating circuit according to the invention for generating a reference voltage which is lower than a bandgap voltage.

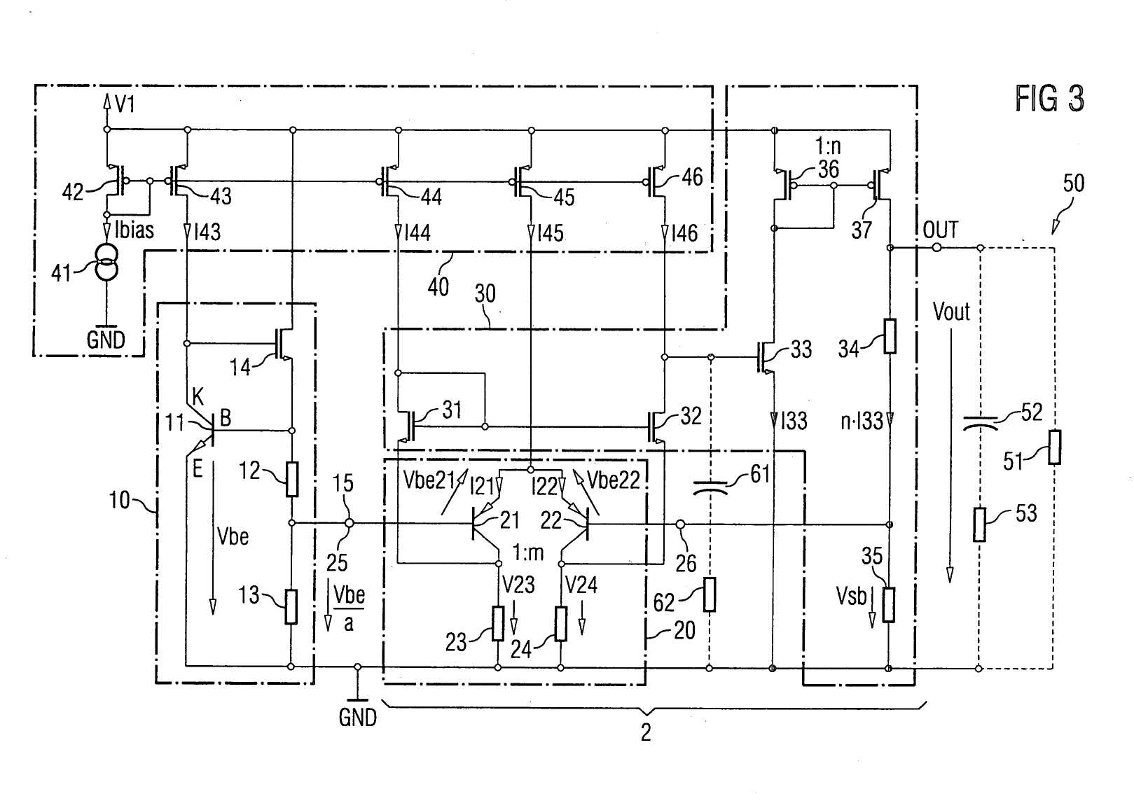

FIG. 3 shows a first exemplary circuit implementation of the reference voltage source according to the invention which has a voltage source arrangement for generating a first reference voltage and an amplifier arrangement with an offset.

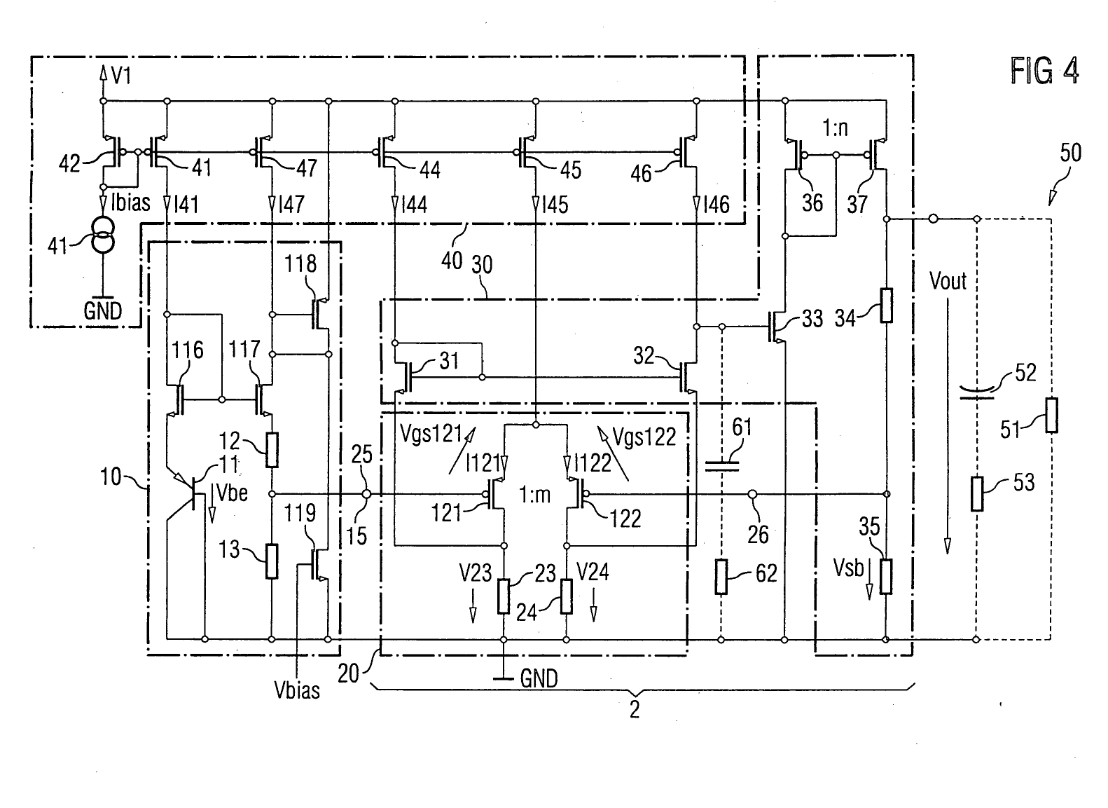

FIG. 4 shows a further exemplary circuit implementation of the reference voltage generating circuit according to the invention.

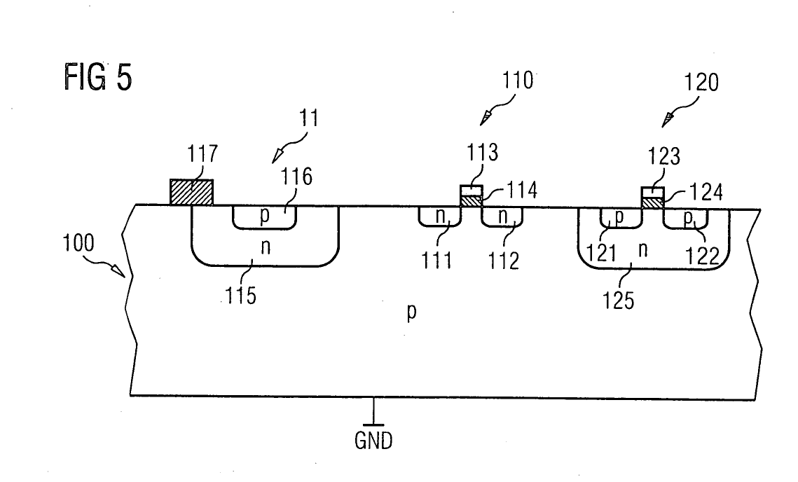

FIG. 5 shows a cross section through a semiconductor body for explaining the implementation of a bipolar transistor in a CMOS circuit.

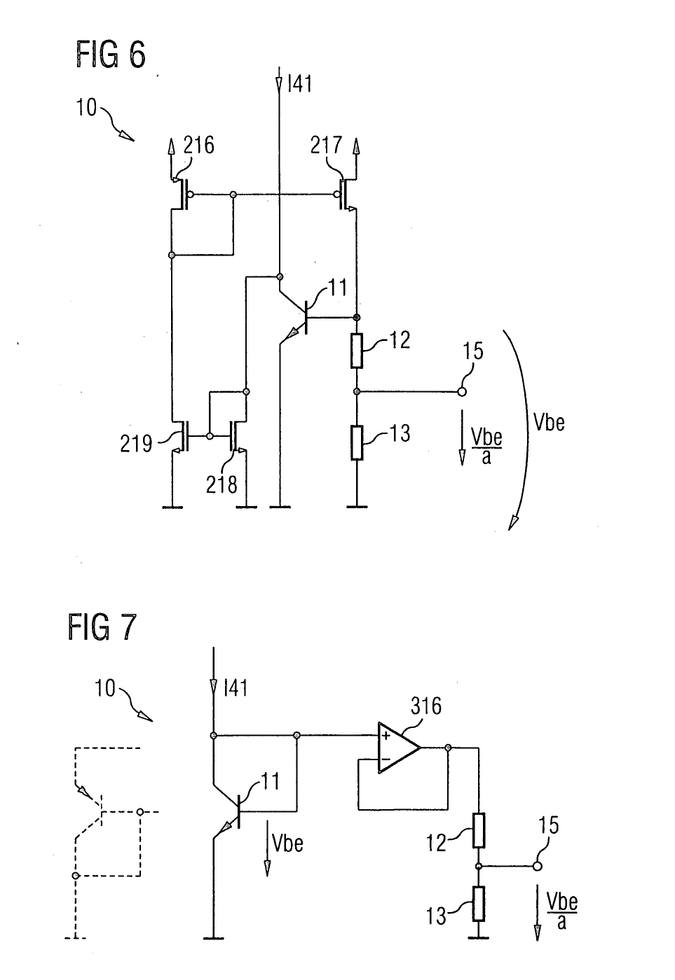

FIG. 6 shows a further exemplary embodiment of the current source arrangement providing the first reference voltage.

FIG. 7 shows a further exemplary embodiment of the current source arrangement.

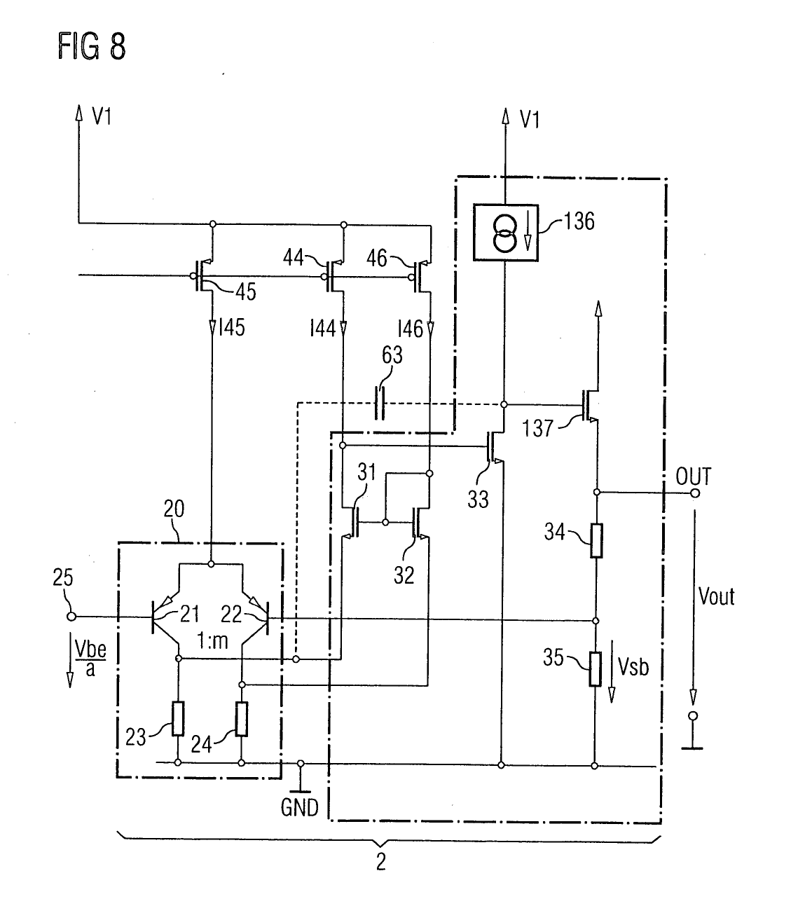

FIG. 8 shows a further exemplary embodiment of the amplifier arrangement with an offset.

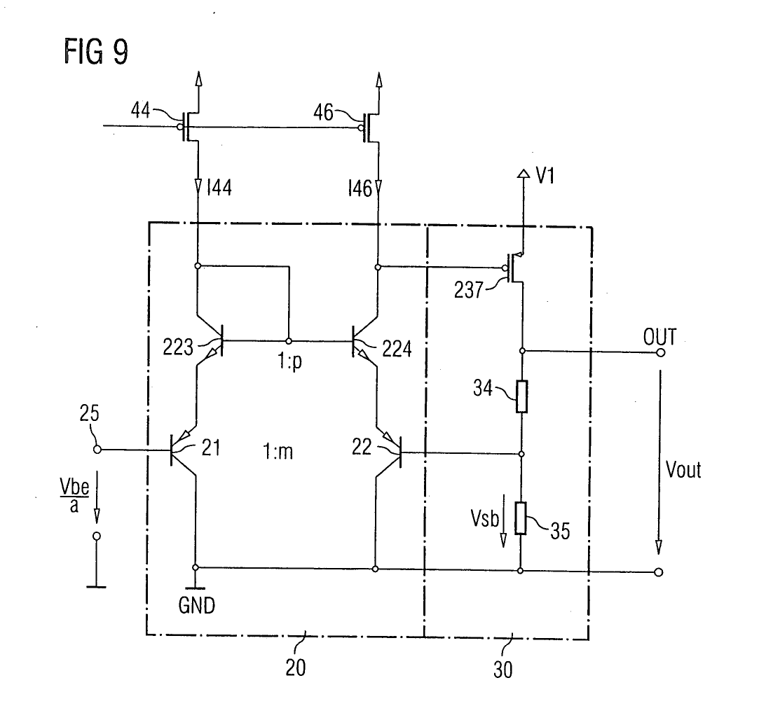

FIG. 9 shows a further exemplary embodiment of the amplifier arrangement.

In the figures, identical reference symbols designate identical circuit components and signals having identical significance, unless otherwise specified.

FIG. 2 illustrates the basic principle of the reference voltage generating circuit according to the invention. The reference voltage generating circuit has a voltage source arrangement 10 which provides a first reference voltage Vref1 at an output 15. This first reference voltage is proportional to the voltage across a pn junction, polarized in the forward direction, of a bipolar component and will be called diode voltage Vbe in the text which follows. The reference voltage Vref1 is lower than this diode voltage Vbe, wherein the following holds true:
Vref1=Vbe/a (3)

where 1/a designates the proportionality factor between the diode voltage Vbe and the first reference voltage Vref1, wherein a>0 holds true.

The voltage source arrangement 10 is followed by an amplifier arrangement 2 with a first and second input 25, 26 and an output 27. The first input 25 of the amplifier arrangement 2 is supplied with the first reference voltage Vref1=Vbe/a. The output 27 of the amplifier arrangement is fed back to the second input 26 and, at the same time, forms an output OUT of the reference voltage generating circuit at which an at least approximately temperature-independent second reference voltage Vref2 is available as output voltage Vout.

The amplifier arrangement 2 is constructed in such a manner that it adds to the first reference voltage Vref1, supplied as input voltage, an offset voltage which is proportional to the thermal voltage of the semiconductor material of the pn junction. Thus, the following applies for the output voltage Vout:
Vout=c·(Vref1=Voffset)=c·(Vbe/a+b·U_{T}) (4)

where c is the gain of the amplifier arrangement 2. The voltage component b·U_{T} designates the offset voltage of the amplifier arrangement 2, where b is the proportionality factor between the material-dependent thermal voltage U_{T} and the offset voltage. This proportionality factor b of the amplifier arrangement 2 can be adjusted by circuit measures as will still be explained in the text which follows. The proportionality factor l/a of the first reference voltage Vref1 and the proportionality factor of the offset voltage Voffset are matched to one another in such a manner that the sum of the temperature coefficients of the first reference voltage Vref1 and the offset voltage Voffset is equal to zero, the following thus holding true:
d(Vref)/dT+d(Voffset)/dT=0 (5).

The total gain factor c of the amplifier arrangement 2 can be adjusted to almost any value of greater than or equal to one. The output voltage Vout of the reference voltage generating circuit according to the invention is proportional to the bandgap voltage of the semiconductor material used for implementing the voltage source arrangement 10 and the amplifier arrangement 2, the following holding true for c=1:
Vout=1/a·Vbg (6)

where Vbg is the bandgap voltage of the semiconductor material used for implementing the voltage source arrangement 10 and the amplifier arrangement 2. The reference voltage generating circuit thus enables a reference voltage to be generated at its output which is lower than the bandgap voltage by the factor a.

FIG. 3 shows an exemplary circuit implementation of the reference voltage generating circuit. The voltage source arrangement 10 which provides the first reference voltage Vref1 at the output 15 has a bipolar transistor 11 which is constructed as npn bipolar transistor in the example. This bipolar transistor 11 is operated with a constant collector current, for which purpose a collector current I43 is impressed on the collector of this bipolar transistor 11 by a current source arrangement 40.

The current source arrangement 40 has a constant current source 41 which provides a constant current Ibias, and a current mirror arrangement 42-46. A diode-connected input transistor 42 of the current mirror arrangement is connected in series with the constant current source 41. The series circuit with the input transistor 42 and the current source 41 is located between a terminal for a first supply potential V1 and a terminal for a second supply potential or reference potential GND. The collector current I43 of the bipolar transistor 11 is available at a first output transistor 43 of the current mirror arrangement 40. This collector current I43 can correspond to the constant current Ibias or can be proportional to the constant current Ibias via the ratio between the transistor areas of the input transistor 42 and of the first output transistor 43.

Between the base terminal and the emitter terminal of the bipolar transistor 11, a voltage divider is connected which has a first and a second ohmic resistance 12, 13 which are connected in series with one another. A center tap of this voltage divider is formed by a node common to the first and second ohmic resistance 12, 13. In the example, this center tap forms the output terminal 15 of the current source arrangement 10.

To adjust a base-emitter voltage Vbe of this bipolar transistor 11, there is a control transistor 14 constructed as n-channel MOSFET, the load current path (drain-source path) of which is connected in series with the voltage divider 12, 13 and connected to the first supply potential V1. A control terminal (gate terminal) of this MOSFET 14 is connected to the collector terminal of the bipolar transistor 11.

The impressed collector current I43 of the bipolar transistor 11 is unambiguously correlated, via the current/voltage characteristic of the bipolar transistor, with a base-emitter voltage which occurs across the voltage divider 12, 13, controlled by the control transistor 14. If the collector current I43 were to drop in the example, the collector-emitter voltage of the bipolar transistor 11 would also drop as a result of which the control transistor 14 would be regulated down in order to correct the base-emitter voltage.

The collector current I43 is preferably selected in such a manner that the bipolar transistor 11 is operated far above its turn-on voltage. Due to the exponential relationship between the collector current and the base-emitter voltage, slight changes in the collector current lead to almost negligible changes in the base-emitter voltage Vbe within this operating range.

At the output of the voltage source arrangement 10, the first reference voltage Vref1=Vbe/a is available which is formed by the voltage divider ratio of the voltage divider 12, 13 from the base-emitter voltage of the bipolar transistor 11. The following applies to this output voltage:
Vref1=1/a·Vbe=R13/(R12+R13)·Vbe (7)

where R12, R13 are the resistance values of the two voltage divider resistors 12, 13.

The base-emitter voltage Vbe of the bipolar transistor 11 is temperature-dependent and has a negative temperature coefficient. In the case of a bipolar transistor consisting of silicon, this temperature coefficient is −2 mV/K at a set operating point for the base-emitter voltage of 0.6 V and at a temperature of 27° C.=300 K. This base-emitter voltage Vbe corresponds to the voltage across the pn junction, polarized in the forward direction, between base and emitter of this bipolar transistor 11.

The first reference voltage generated from the base-emitter voltage Vbe by the voltage divider 12, 13 is supplied to the first input 25 of the amplifier arrangement 2 which follows the voltage source arrangement 10. This amplifier arrangement 2 has a differential input stage 20 and an output stage 30 at which the second reference voltage Vref2 or the output voltage Vout, respectively, is available. The output voltage Vout is fed back to a second input 26 of the differential input stage 20. In the example, the output voltage Vout is fed back to the second input 26 by means of a voltage divider having two voltage divider resistors 34, 35 so that only a part of the output voltage Vout is present at the second input 26 in the example, for which part the following holds true:
Vsb=R35/(R34+R35)·Vout (8)

where R34, R35 are the resistance values of the voltage divider resistors 34, 35 which are connected in series between the output terminal OUT and reference potential GND.

The differential input stage 20 has a first and a second input transistor 21, 22 which are implemented as pnp bipolar transistors in the example. The emitter terminals of these two input transistors 21, 22 are short-circuited and jointly connected to a further output transistor 45 of the current mirror arrangement of the current source arrangement 40. This further output transistor 45 provides a constant current I45 which is proportional to the constant current Ibias delivered by the current source 41. In the example, this current I45 is proportional to the current which is impressed on the collector of the bipolar transistor 11 of the voltage source arrangement 10 which, however, is not a prerequisite for the correct operation of the circuit. Moreover, the two currents I45, I43 are not necessarily equal.

Between the collector terminals of the input transistors 21, 22 of the differential input stage and the reference potential GND, an ohmic resistance 23, 24 is in each case connected. These two resistances 23, 24 preferably have identical resistance values so that R23=R24, where R23, R24 are the resistance values of these two resistances.

The output stage 30 of the amplifier arrangement 2 forms a control arrangement which sets the base potential of the second input transistor 22, i.e. the potential at the second input 26 of the input stage, in such a manner that an identical current in each case flows through the two input transistors 21, 22. An identical current through these two transistors 21, 22 is present when the voltages V23, V24 across the ohmic resistances 23, 24 following the input transistors 21, 22 are in each case equal. A comparator arrangement compares the voltages V23, V24 across these two resistances 23, 24 and, depending on the result of the comparison, drives a control transistor 33 which regulates a current through the voltage divider 34, 35 by a further current mirror 36, 37. The voltage Vsb present across the resistance 35 connected to the reference potential GND is supplied to the second input 26 or, respectively, the base of the second input transistor 23.

A current mirror with a diode-connected input transistor 31, constructed as n-channel MOSFET in the example, and with an output transistor 32 is used as comparator arrangement for comparing the voltages V23, V24. The current mirror ratio of this current mirror is preferably 1:1. The input and output transistor 31, 32 of this current mirror are supplied with identical currents I44, I46 via further current mirror transistors 44, 46 of the current source arrangement 40. The input transistor 31 of the current mirror is connected to a node common to the input transistor 21 at the input stage and the ohmic resistance 23, and the output transistor 32 of the current mirror is connected to a node common to the second input transistor 22 of the input stage and the subsequent ohmic resistance 24. The currents I44, I46 flowing through the current mirror transistors 31, 32 lead to an additional voltage drop across the ohmic resistances 23, 24. Since the currents I44, I46 flowing through the current mirror transistors 31, 32 are in each case equal and because the resistances 23, 24 are equal, these additional voltage drops are of equal magnitude.

In the example, the output of the comparator arrangement formed by the current mirror 31, 32 is formed by the terminal (drain terminal) of the output transistor 32 of the current mirror arrangement 31, 32 facing away from the ohmic resistance 24. In the corrected state, the voltages V23, V24 across the ohmic resistances 23, 24 correspond to one another. The drain potential of the output transistor 32 of the current mirror then corresponds to the drain potential of the input transistor 31 and the voltage drops across the load current paths of these two current mirror transistors 31, 32 are equal. If then the emitter potential of the second input transistor 32 of the input stage rises, the drain potential of the output transistor of the current mirror increases as a result which turns on the control transistor 33. This increases the current I33 through the control transistor 33 and thus also the current through the voltage divider 34, 35, with the consequence that the base potential of the second input transistor 22 is raised compared with the reference potential GND via the feedback branch, which reduces the amount of the base-emitter voltage Vbe22 of the second input transistor 22 and regulates the transistor 22 down until the voltage V24 corresponds to the voltage V23 which is achieved when the currents through the two input transistors 21, 22 are in each case equal. In the opposite case, when the voltage V24 drops below the voltage V23, the control transistor 33 is regulated down as a result of which the current through the voltage divider 34, 35 is reduced. This lowers the base potential of the second input transistor 22 in the direction of the reference potential GND which increases the amount of the base-emitter voltage Vbe22 of the second input transistor 22 and turns on this second input transistor 22 in order to increase the currents through this second input transistor 22.

The input transistors 21, 22 of the differential stage are dimensioned in such a manner that the ratio of their transistor areas is 1:m, where m>1. The base-emitter voltage Vbe22 of the second input transistor adjusts itself to a lower value than the base-emitter voltage Vbe21 of the first input transistor 21 when an identical current I21=I22 flows through both input transistors. The following holds true for the difference between these two base-emitter voltages Vbe21, Vbe22:
Vbe21−Vbe22=ln(m)·U_{T} (9)

where U_{T} is the thermal voltage of the semiconductor material used for implementing the input transistors 21, 22. This material is the same material which is also used for implementing the bipolar transistor 11 in the voltage source arrangement. It should be noted in this context that the entire arrangement is preferably integrated in a common semiconductor body.

The emitters of the two input transistors 21, 22 are short-circuited and are thus at the same potential. The following holds true for the first reference voltage Vbe/a present between the base of the first input transistor 21 and reference potential GND, the base-emitter voltage Vbe21 of the first transistor, the feedback voltage applied between the base of the second input transistor 22 and reference potential GND, and the base-emitter voltage Vbe22 of the second input transistor 22:
Vbe21+Vbe/a=Vbe22+Vsb (10).

Using equation (9), the following is obtained for the feedback voltage Vsb:

$$\begin{matrix}Vsb = Vbe / a + ln ( m ) \cdot {U}_{T} \\ = Vbe / a + ln ( m ) \cdot k \cdot T / q \\ = Vbe / a + Voffset .\end{matrix} \qquad ( 11 )$$

This feedback voltage Vsb thus corresponds to the sum of the input voltage Vbe/a present at the first input 25 plus an offset added by the differential input stage. This offset Voffset, which is proportional to the temperature, has a positive temperature coefficient whereas the first voltage component Vbe/a has a negative temperature coefficient in the manner explained. This feedback voltage Vsb is lower than the bandgap voltage of the semiconductor material used, wherein the proportionality factor 1/a and the ratio of areas 1:m of the transistors 21, 22 of the input stage have to be matched to one another in such a manner that the sum of the temperature coefficients of the two voltage components of this feedback voltage Vsb is zero. The following thus applies:
d(Vbe/a)/dT+d/dT(ln(m)·k·T/q)=0 (12).

When silicon is used as semiconductor material, where dVbe/dT=−2 mV/K, this is achieved when a·ln(m)˜23.

The output voltage Vout of the reference voltage generating circuit is dependent on the feedback voltage Vsb via the divider ratio of the voltage divider 34, 35. The output voltage Vout corresponds to the feedback voltage Vsb which is lower than the bandgap voltage when the resistance value of the ohmic resistance 34 is set as zero. Otherwise, any proportionality factors between the output voltage Vout and the feedback voltage Vsb can be set by the divider ratio of the voltage divider.

The reference voltage generating circuit according to the invention is suitable for supplying any loads with voltage. In FIG. 3, such a load 50 which has a capacitive component 52 and ohmic resistance elements 51, 53 is shown by way of example.

For compensation purposes, a series circuit of a compensation resistor 62 and a compensation capacitor 61 is preferably connected between the control terminal of the control transistor 33 and reference potential GND. These compensation components increase the stability of the control path with the control transistor 33 and prevent an oscillatory behavior in the case of rapid changes in the potential at the input of the control transistor 33.

A further exemplary embodiment of a reference voltage generating circuit according to the invention is shown in FIG. 4.

This circuit differs from the one shown in FIG. 3 in the type of implementation of the voltage source arrangement 10 and in that MOS transistors 121, 122 are used in the differential input stage 20 instead of bipolar transistors (21, 22 in FIG. 3). This circuit can be implemented completely in CMOS technology, including the bipolar component of the voltage source arrangement 10, as a result of which the reference voltage generating circuit can be cost-effectively implemented as will still be explained in the text which follows.

In the example, the bipolar component of the voltage source arrangement 10 is constructed as pnp bipolar transistor 11 which is connected as a diode and the collector and base of which are thus short circuited. Collector and base of the bipolar transistor 11 are jointly connected at reference potential GND. On this transistor, a constant current I41 which is proportional to the constant current Ibias supplied by the current source 41 is impressed by the current source arrangement 40. The current source arrangement 10 also has a voltage divider with two voltage divider resistors 12, 13 and a control circuit 116-119 which sets a voltage across the voltage divider 12, 13 to a value which corresponds to the value of the voltage across the diode-connected bipolar transistor 11. The control circuit 116-119 comprises a current mirror with a diode-connected input transistor 116 which is connected into the current path of the bipolar transistor 11, and with an output transistor 117 which is connected in series with the voltage divider 12, 13. The current source arrangement 40 feeds a current I47 into the voltage divider 12, 13, which current is delivered by a further output transistor 47 of the current source arrangement 40 and which is preferably adjusted via the ratio of the two transistors 41, 47 in such a manner that it corresponds to the current I41 flowing through the bipolar transistor 11.

The control circuit 116-119 also has a control transistor 118 which, in the example, is constructed as p-channel MOSFET and the control terminal (gate terminal) of which is connected to the load terminal of the output transistor 117, facing away from the voltage divider 12, 13, of the current mirror 116, 117. The load current path of this control transistor 118 is connected between the first supply potential V1 and the voltage divider 12, 13. In parallel with the voltage divider 12, 13, there is a further transistor 119 which is used as load for the control transistor 118 and which is constructed as n-channel MOSFET and at the control terminal of which a bias voltage Vbias is present. The operation of this control circuit 116-119 will be explained briefly in the text which follows.

In the adjusted state, when the voltage across the voltage divider 12, 13 corresponds to the voltage Vbe present across the bipolar transistor 11, the potentials at the terminals, facing away from the bipolar transistor 11 or the voltage divider 12, 13, respectively of the current mirror transistors 116, 117, through which identical currents I41 and I47, respectively, flow in each case, are identical. If the voltage across the voltage divider 12, 13 drops below the voltage Vbe across the bipolar transistor 11, the control transistor 118 is turned on further as a result of which an additional current is fed into the voltage divider 12, 13 in order to raise the voltage across the voltage divider 12, 13. In the opposite case, when the voltage across the voltage divider 12, 13 rises above the voltage Vbe of the bipolar transistor 11, the control transistor 118 is regulated down and the load transistor 119 fulfilling the function of a current sink then takes over a part of the current I47 flowing in the direction of the voltage divider as a result of which the voltage across the voltage divider 12, 13 drops in order to adjust the voltage across this voltage divider 12, 13 to the value of the voltage across the bipolar transistor 11.

Corresponding to the voltage source arrangement shown in FIG. 3, the second voltage divider resistor 13 is connected between the output 15 of the voltage source arrangement 10 and the reference potential GND so that in this voltage source arrangement 10, too, the first reference voltage Vbe/a is present across the second voltage divider resistor 13.

The configuration of the amplifier arrangement 2 in the reference voltage generating circuit according to FIG. 4 corresponds to the configuration of the amplifier arrangement 2 according to FIG. 3, the difference being that instead of bipolar transistors, p-channel MOSFETs 121, 122 are used in the differential input stage. These two MOSFETs 121, 122 of the differential input stage are operated in the so-called sub-threshold range, i.e. the two MOSFETs are operated with gate-source voltages Vgs121, Vgs122 which are lower than the turn-on voltages or threshold voltages of these two transistors. In this sub-threshold range, the currents I121, I122 flowing through the MOSFETs are exponentially dependent on the gate-source voltage Vgs121, Vgs122 present in each case, corresponding to the characteristic of a bipolar transistor.

The two transistors 121, 122 are dimensioned in such a manner that the ratio of the transistor areas is 1:m, where m>1. The relationship specified in equation (11) then applies to the voltage Vsb fed back to the second input 26 and thus to the control terminal of the second input transistor 122. The output voltage Vout is dependent on this feedback voltage Vsb in accordance with the divider ratio of the voltage divider 34, 35. The feedback voltage Vsb is controlled in the manner already explained with reference to FIG. 3 so that further statements relating to this can be omitted.

As already mentioned, the reference voltage generating circuit according to FIG. 4 can be implemented completely in CMOS technology. As will be explained with reference to FIG. 5 in the text which follows, a parasitic bipolar transistor present in any CMOS circuit can be used as bipolar transistor 11 of the voltage source arrangement 10.

FIG. 5 diagrammatically shows a cross section through a semiconductor body 100 which has a basic p-type doping and in which both n-channel MOSFETs and p-channel MOSFETs can be implemented by suitable mask techniques. FIG. 5 shows by way of example one such n-channel MOSFET 110 and one p-channel MOSFET 120 in each case. The n-channel MOSFET 110 comprises n-doped source and drain zones 111, 112 which are introduced into the semiconductor body 100. A conducting channel in an area between source and drain 111, 112 which has the basic doping can be controlled by a gate electrode 113 which is insulated from the semiconductor body 100 by an insulation layer 114.

To implement a p-channel MOSFET, there is an n-doped well 125 in the semiconductor body 100, into which wells 121, 122 p-doped at a distance from one another are introduced which form the source and drain zones of this MOSFET. In an area between source and drain zone 121, 122 having n-type doping, a conducting channel can be controlled by means of a gate electrode 123. The gate electrode 123 is insulated from the semiconductor body 100 by means of an insulation layer 124.

In the case of CMOS circuits, the semiconductor body 100 having a basic p-type doping is usually at the most negative potential occurring in the circuit, usually reference potential GND. A bipolar transistor with a collector at reference potential GND as shown in FIG. 4 (reference symbol 11), can be created in a simple manner in that an n-doped well 115 is introduced into the semiconductor body 100 and a p-doped well 116 is introduced into this n-doped well. As a result, a pnp bipolar transistor is produced, the collector of which is formed by an area having the basic doping of the semiconductor body and the emitter of which is formed by the p-doped well 116. The n-doped well 115 and the area of the semiconductor body having the basic doping are short circuited by an electrode 117 in order to obtain the diode-connected bipolar transistor.

An essential aspect of the present invention consists in providing a first reference voltage which is proportional to the voltage across a pn junction, polarized in the forward direction, of a bipolar component, and in that this first reference voltage is supplied to a feedback amplifier with an offset, the offset of this feedback amplifier being proportional to the temperature voltage of the semiconductor material used for implementing the amplifier.

Apart from the exemplary embodiments for the voltage source arrangement 10 and the amplifier arrangement 2 with an offset, explained by means of FIGS. 3 and 4, there are many other possibilities for implementing a voltage source arrangement which supplies a voltage proportional to the voltage across a pn junction polarized in the forward direction, and implementing an amplifier arrangement with an offset proportional to a thermal voltage.

FIG. 6 shows a modification of the voltage source arrangement shown in FIG. 3 in which the voltage divider 12, 13 is connected between base and emitter of an npn bipolar transistor 11. The voltage source arrangement shown in FIG. 6 is suitable, in particular, for generating the first reference voltage Vbe/a from a low supply voltage or a low supply potential V1, respectively. In this arrangement, a transistor 217 regulating the currents with the voltage divider 12, 13 is implemented as p-channel MOSFET, the load current path of which is connected between the voltage divider 12, 13 and the supply potential V1. This control transistor 217 forms the output transistor of a first current mirror which, apart from the output transistor 217, has a diode-connected input transistor 216 which is also implemented as p-channel MOSFET. The load current path of this input transistor 216 is in series with an output transistor 219 of a second current mirror between the supply potential V1 and reference potential GND. A diode-connected input transistor 218 of this second current mirror is connected to the collector terminal of the bipolar transistor 11. The two transistors of the second current mirror 218, 219 are implemented as n-channel MOSFETs.

The control arrangement with the two current mirrors regulates the currents through the voltage divider 12, 13 to a value at which the voltage drop Vbe across the voltage divider corresponds to the value which is correlated with the impressed collector current I41 via the characteristic of the bipolar transistor 11. The control mechanism will be explained briefly in the text which follows:

if a current I41 flows with the bipolar transistor 11 initially cut off, this current flows via the input transistor 218 of the second current mirror. This current is mapped onto the voltage divider 12, 13 via the first current mirror as a result of which the bipolar transistor 11 is turned on until the base-emitter voltage Vbe and the collector current I41 are in an equilibrium given by the characteristic of the bipolar transistor 11. The base-emitter voltage is correspondingly corrected in the case of fluctuations of the collector current I41.

FIG. 7 shows a further exemplary implementation of the voltage source arrangement 10. This voltage source arrangement 10 has a diode-connected npn bipolar transistor 11 through which an impressed current I41 flows. The voltage Vbe is detected via the diode-connected bipolar transistor 11 by a buffer-connected amplifier 316 with feedback which maps this voltage across a voltage divider 12, 13 following the output of the amplifier 316.

Naturally, as shown dashed in FIG. 7, the npn bipolar transistor could also be replaced by a diode-connected pnp bipolar transistor.

FIG. 8 shows a modification of the amplifier arrangements shown in FIGS. 3 and 4. In the output stages 30 according to FIGS. 3 and 4, an output transistor 37, which is connected to the output OUT and which delivers the currents through the voltage divider 34, 35, is implemented as p-channel MOSFET and is a part of a current mirror, the input transistor 36 of which is connected in series with the control transistor 33.

In the exemplary embodiment according to FIG. 7, an output transistor 137 is implemented as n-channel MOSFET and driven directly by the control transistor 33. In this arrangement, the control transistor 33 is connected between the control terminal of this output transistor 137 and reference potential. To provide an adequate drive potential for this output transistor 137, a charge pump arrangement 136 is provided which is shown only diagrammatically in FIG. 7. This charge pump arrangement 136 generates from the supply potential V1 a drive potential for the output transistor 137 which is above the supply potential V1.

A further difference from the amplifier arrangement in FIGS. 3 and 4 consists in that the amplifier arrangement in FIG. 7, the voltage V23 across the resistor 23 following the first input transistor 21 of the differential stage is detected for driving the control transistor 33. Correspondingly, the MOSFET 32 connected to the node common to the resistor 24 and the second input transistor 22 forms the input transistor of the current mirror used as comparator. Despite this difference, however, the control characteristic of this arrangement is identical with the control characteristic of the arrangements explained in FIGS. 3 and 4.

FIG. 9 shows a further exemplary embodiment of the amplifier arrangement 2. The input transistors 21, 22 of the differential input stage 20 are constructed as pnp bipolar transistors with an area ratio of 1:m. These bipolar transistors, however, can also be correspondingly implemented by p-channel MOSFETs. The input transistors 21, 22 are in each case supplied with identical currents I44, I46 via a current mirror 223 from the current source arrangement of which only two output transistors 44, 46 are shown in FIG. 9. In this example, the current mirror transistor 223 connected in series with a first input transistor 21 is connected as a diode. The two current mirror transistors are implemented as npn bipolar transistors, but can also be implemented as n-channel MOSFETs.

In this arrangement, an output transistor 237 of the output stage 30 which is connected in series with the voltage divider 34, 35 between supply potential V1 and reference potential GND at the same time fulfils the function of the control transistor. The control terminal of this transistor 237 is connected to the terminal of the current mirror transistor 224 facing away from the second input transistor 22 of the differential stage. This control transistor 237 adjusts the base potential of the second input transistor 22 of the differential stage via the voltage divider 34, 35 in such a manner that the currents through the two input transistors 21, 22 are in each case identical. If the ratio between the two current mirror transistors 223, 224 is 1:1, the voltage Vsb fed back is dependent on the first reference voltage Vbe/a and the offset voltage Voffset in accordance with equation (11). Correspondingly, the output voltage Vout is proportional to this feedback voltage Vsb via the divider ratio of the voltage divider 34, 35.

As already explained, the proportionality factor 1/a of the first reference voltage Vbe/a and the area ratio 1:1 of the input transistors 21, 22 must be in a certain ratio with respect to one another in order to obtain a feedback voltage Vsb which is at least approximately independent of the temperature.

A further possibility for adjusting the feedback voltage Vsb is obtained when the transistor areas of the current mirror transistors 223, 224 are selected to be unequal in a ratio 1:p, with p>1. With identical currents I44, I46, the base-emitter voltage across the output transistor 22 of the current mirror will be lower than that across the input transistor 223. As a result, the emitter potential of the second input transistor 22 of the differential stage, referring to the reference potential GND, is higher than the emitter potential of the first input transistor 21. Taking into consideration the lower base-emitter voltage Vbe22 of the second input transistor occurring because of the greater transistor area in comparison with the first input transistor 21, the feedback voltage Vsb is in this case greater than with a current mirror ratio 1:1 of the current mirror transistors 223, 224. In this case, the following applies to the feedback voltage Vsb:
Vsb=Vbe/a+U_{T}·ln(m·p) (13).

With a current mirror ratio of the two current mirror transistors 223, 224 unequal to 1:1, the input transistors 21, 22 can also be selected to be of equal size. The following would then apply to the feedback voltage Vsb:
Vsb=Vbe/a+U_{T}·ln(p) (14).

For the previous explanation, it was assumed that the offset of the amplifier arrangement 30 is achieved by the two input transistors 21, 22 (in FIG. 3, 8 and 9) and 121, 122 (in FIG. 4) being differently dimensioned and the currents I21, I22 and I121, I122, respectively, being regulated in such a manner that they are of equal magnitude. In this case, the base-emitter voltages or gate-source voltages, respectively, of the input transistors will be different which leads to the desired offset.

A further possibility for generating the offset of the amplifier stage 30 consists in dimensioning the input transistors 21, 22 and 121, 122, respectively, identically, i.e. with a transistor ratio of 1:1, but to impress different currents I21, I22 or I121, I122, respectively, on the transistors 21, 22 and 121, 122, respectively. The same conditions as in the case of the different dimensionings with area ratios of 1:m, explained by means of FIGS. 3, 4 and 8, can be achieved with identical transistors 21, 22 and 121, 122, respectively, if a current I22, I122 which is 1/m-times the current I21, I121 through the first transistor 21, 121 flows through the second input transistor 22 and 122, respectively. Such different currents can be achieved in the circuits according to FIGS. 3, 4 and 8 by the resistor following the second transistor 22 or 122, respectively, having m-times the resistance value of the resistor 23 following the first transistor 21 and 121, respectively.

Naturally, a combination of different transistor areas and different currents impressed on the transistors can be applied for achieving the offset.

The reference voltage generating circuit according to the invention enables a reference voltage Vout which can be lower than the bandgap voltage of the semiconductor material used for implementing the reference voltage generating circuit to be generated in a simple manner.

### LIST OF REFERENCE DESIGNATIONS

I121, I122 Drain-source currents
I21, I22 Emitter currents
I43-I47 Output currents of the current mirror arrangement
Ibias Constant current
OUT Output of the reference voltage generating circuit
V1 Supply potential
V23, V24 Voltages across ohmic resistances
Vbe21, Vbe22 Base-emitter voltages
Vbg Bandgap voltage
Vgs121, Vgs122 Gate-source voltages
Vout Output voltage
Vref1 First reference voltage
Vref2 Second reference voltage
Vsb Sub-bandgap voltage
2 Amplifier arrangement
10 Voltage source arrangement
11 Bipolar transistor
12, 13 Voltage divider
14 Control transistor
15 Output of the voltage source arrangement
20 Differential input stage of the amplifier arrangement
21, 22 Input transistors
23, 24 Ohmic resistances
25 First input of the amplifier arrangement
26 Second input of the amplifier arrangement
27 Output of the amplifier arrangement
30 Output stage of the amplifier arrangement
33 Control transistor
36, 37 Current mirror transistors
40 Current source arrangement
41 Constant current source
42-47 Current mirror transistors
50-53 Load
61 Compensation capacitor
62 Compensation resistor
100 Semiconductor body
110 n-channel MOSFET
111, 112 n-doped semiconductor zones
113, 123 Gate electrodes
114, 124 Gate insulations
115 n-doped semiconductor zone
116 p-doped semiconductor zone
117 Short-circuit electrode
120 p-channel MOSFET
121, 122 MOSFETs
121, 122 p-doped semiconductor zones
125 n-doped semiconductor zone
127 Output transistor of the output stage
136 Charge pump
213, 214 Voltage divider
216, 217 Current mirror transistors
218, 219 Current mirror transistors
223, 224 Current mirror transistors
200 Bandgap reference
237 Output transistor of the output stage
300 Operational amplifier
316 Operational amplifier

1. A reference voltage generating circuit comprising:
a voltage source circuit (10) which is constructed for providing at an output (15) a first reference voltage (Vbe/a) which is proportional to the voltage (Vbe) across a pn junction, polarized in the forward direction, of a bipolar component (11) and which is lower than this voltage,
an amplifier arrangement (2) having a first and second input (25, 26), an output (27) at which an output voltage (Vout) is available, a differential amplifier stage (20) which has at least two semiconductor components (21, 22; 121, 122), and an output stage (30), the first reference voltage (Vbe/a) being supplied to the first input (25), the output (27) being fed back to the second input (26) and the amplifier arrangement having an offset which is proportional to the thermal voltage of a semiconductor material of the at least two semiconductor components (21, 22; 121, 122) of the differential amplifier stage (20) and wherein a second reference voltage (Vout) is available at the output (OUT).

2. The reference voltage generating circuit as claimed in claim 1, in which the differential amplifier stage (20) has a first input transistor (21; 121) which is driven in dependence on the first reference voltage (Vbe/a), and a second input transistor (22; 122) which is driven in dependence on the output voltage (Vout), and in which the output stage (30) has a control arrangement for regulating the current through the second input transistor (22; 122).

3. The reference voltage generating circuit as claimed in claim 2, in which the control arrangement has a voltage divider (34, 35) via which the output voltage (Vout) is fed back to a control input of the second input transistor (22) of the differential stage (20).

4. The reference voltage generating circuit as claimed in claim 3, in which the input transistors (21, 22; 121, 122) have different transistor areas and in which the control arrangement is constructed for adjusting the current (I22; I122) through the second input transistor (22; 122) to the value of the current (I21; I121) though the first input transistor (21; 121).

5. The reference voltage generating circuit as claimed in claim 3, in which the input transistors (21, 22; 121, 122) have identical transistor areas and in which the control arrangement is constructed for regulating the current (I22; I122) through the first and second input transistor (21, 22; 121, 122) to different values.

6. The reference voltage generating circuit as claimed in claim 2, in which the control arrangement has a current mirror with a first current mirror transistor (223), which is connected in series with the first input transistor (21), and with a second current mirror transistor (224), which is connected in series with the second input transistor (22), and in which the control arrangement is constructed for comparing the potentials at the terminals of the current mirror transistors (223, 224) facing away from the input transistors, in order to set the output voltage (Vout).

7. The reference voltage generating circuit as claimed in claim 6, in which the current mirror transistors (223, 224) have different transistor areas.

8. The reference voltage generating circuit as claimed in claim 2, in which the input transistors (21, 22) are bipolar transistors.

9. The reference voltage generating circuit as claimed in claim 2, in which the input transistors (121, 122) are MOS transistors.

10. The reference voltage generating circuit as claimed in claim 2, in which the voltage source circuit (10) has the following:
a bipolar transistor (11), the collector-emitter path of which is connected in series with a current source (43),
a voltage divider (12, 13) which is connected between base and emitter of the bipolar transistor (11),
a control circuit ( ) which is connected between the collector terminal (K) of the bipolar transistor (11) and the voltage divider.

11. The reference voltage generating circuit as claimed in claim 10, in which the control circuit has a control transistor (14) with a control input and a load current path, the control input of which is connected to the collector terminal of the bipolar transistor (11) and the load current path of which is connected in series with the voltage divider (12, 13) and is connected to a supply potential (V1).

12. The reference voltage generating circuit as claimed in claim 11, in which the control circuit has the following:
a first current mirror with an output transistor (217) which has a load current path which is connected in series with the voltage divider (12, 13) and is connected to a supply potential (V1), and with an input transistor (216),
a second current mirror with an input transistor (218) which is connected in parallel with the bipolar transistor (11), and with an output transistor (218) which has a load current path which is connected in series with the load current path of the input transistor (216) of the first current mirror (216, 217).

13. The reference voltage generating circuit as claimed in claim 2, in which the first voltage source circuit (10) has the following:
a diode-connected bipolar transistor (11), —a voltage divider (12, 13),
a control arrangement (116-119; 316) which is connected between the bipolar transistor (11) and the voltage divider and which is constructed for adjusting a voltage across the voltage divider to the value of a voltage (Vbe) across the diode-connected bipolar transistor (11).

14. A method for providing a temperature-independent reference voltage (Vout) which comprises the following method steps:
providing a first voltage (Vbe/a) which is proportional to the voltage (Vbe) across a pn junction polarized in the forward direction, and which is lower than this voltage;
adding a second voltage (Voffset) to the first reference voltage, which is proportional to the thermal voltage (UT) of the semiconductor material of the pn junction, the proportionality factors between the first voltage (Vbe/a) and the voltage at the pn junction and between the second voltage (Voffset) and the thermal voltage (UT) being matched to one another in such a manner that the sum of the temperature coefficients of the first and second voltage (Vbe/a, Voffset) is zero.

15. The method as claimed in claim 14, in which the second voltage (Voffset) is derived from the difference of the drive voltages of two transistors (21, 22; 121, 122) through which identical currents flow, and which have different transistor areas.

16. The method as claimed in claim 15, in which the transistors (21, 22) are bipolar transistors.

17. The method as claimed in claim 15, in which the transistors (121, 122) are MOS transistors.
